(19) United States
(12) Patent Application Publication
(10) Pub. No.: US 2009/0119314 A1
(43) Pub. Date: May 7, 2009

(54) Method for Storing Individual Data Elements of a Scalable Bit Stream in File, and Associated Device

(76) Inventors: Peter Amon, Munchen (DE); Andreas Hutter, Munchen (DE); Thomas Rathgen, Ilmenau (DE)

Correspondence Address: STAAS & HALSEY LLP, SUITE 700, 1201 NEW YORK AVENUE, N.W., WASHINGTON, DC, 20005, US

(21) Appl. No.: 11/989,103

(22) PCT Filed: Jun. 16, 2006
(86) PCT No.: PCT/EP2006/063268

§ 371 Date: Jan. 22, 2008

(30) Foreign Application Priority Data
Jul. 20, 2005 (DE) 10 2005 033 981.6

(51) Int. Cl. G06F 17/30

(52) U.S. Cl. 707/100; 707/E17.01

(57) ABSTRACT

Data elements of a scalable data flow are individually stored in at least one file with quality levels of the scalable data flow described by at least one scaling feature in respective scaling levels and at least one data element is associated with every scaling level of the scaling features. A processing index is allocated to each data element so that only data element(s) having a value lower than that processing index must be taken into consideration for processing. At least one descriptive list, containing descriptive elements associated with the data element, namely the scaling level of the respective scaling features, the time index and/or the processing index, is stored in one of the files.

### CROSS REFERENCE TO RELATED APPLICATIONS

This application is based on and hereby claims priority to German Application No. 10 2005 033 981.6 filed on 20 Jul. 2005, the contents of which are hereby incorporated by reference.

### BACKGROUND

In many applications, media bit streams such as video bit streams or audio bit streams are required in different qualities. For example, a cell phone is only capable of reproducing the video bit stream with a low picture resolution, e.g. 176×144 pixels. On the other hand, portable computers such as a tablet PC can display the video bit stream with up to 1280×768 pixel resolution on their displays.

In order to provide a media bit stream for different terminals having different terminal characteristics, the media bit stream can be converted into a plurality of different quality bit streams. This procedure is disadvantageous, as a large memory capacity must be provided for storing this large number of bit streams for one media bit stream.

In another variant, the media bit stream is encoded into a basic bit stream and a plurality of subset bit streams, a quality improvement, e.g. picture quality, compared to the basic bit stream being achieved by adding one or more subset bit streams to the basic bit stream. By using this scalable coding, a terminal can, through the addition of one or more subset bit streams to the basic bit stream, obtain a to-be-decoded bit stream with a selectable quality such that the bit stream is suitable for the equipment characteristics of the specific terminal. This scalable coding means, on the one hand, that less memory space is required and, on the other, that matching of the equipment characteristics for the terminals can be provided by the addition of one or more subset bit streams.

Coded media bit streams, such as a video bit stream, are stored in a file system. “Coding of Moving Pictures and Audio, Information Technology—Coding of Audio-Visual Objects, Part 15: AVC Fileformat”, ISO, JTC1/SC29/WG11, MPEG03/N5652, 21 Mar. 2003, for example, discloses a file format in which coded media bit streams are stored. According to section 7 of this document, this file format supports “layers” and “sub-sequences”, it being explicitly indicated that that the layers and sub-sequences are limited to the reading of the data format, whereas this information is not intended for describing characteristics of a codec, i.e. scalable bit streams.

Reference is further made to M. Z. Wisharam et al., “Extensions to ISO/AVC Fileformat to Support the Storage of Scalable Videocoding (SVC) Bitstreams”, ISO/IEC JTC1/SC29/WG11, MPEG2005/M12062, Buthan, Korea, April 2005, which defines a special hierarchical format with a fixed structure for the sequence of scalability directions, i.e. for a specific preferred application. The disadvantage of the format proposed by Wisharam et al. is that it supports no flexible definition of scaling directions.

### SUMMARY

An aspect is to specify a method and a device whereby, in creating at least one file for storing scalable bit streams, there is provided a simple and efficient way to both flexibly define scaling directions and match the scalable bit streams to equipment characteristics of one or more different terminals.

With the method for storing individual data elements of a scalable bit stream in at least one file, wherein quality levels of the scalable bit stream are described by at least one scaling feature in a plurality of scaling levels in each case, each scaling level of the scaling features is assigned at least one data element in each case, the scalable bit stream is represented at a high quality level by at least one of the data elements whose scaling feature scaling levels are equal to or less than the scaling feature scaling levels associated with the high quality level, and the data element is assigned a time index at which the respective data element is to be represented relative to other data elements, the data element is assigned a processing index such that, to process the data element, only one or a plurality of data elements with a lower value of the respective processing index are to be taken into account, at least one description list is generated such that it contains data-element-associated description elements containing the scaling level of the respective scaling features, the time index and/or the processing index, and at least one of the description lists and the associated data elements are stored in an organized manner in one of the files.

The method provides that data elements and their description, which are represented in the form of at least one description list, can be stored in a very flexible manner.

If the description elements are arranged in the description list in an organized manner according to at least one sort criterion, in particular sorted from the lowest scaling level to the highest scaling level, rapid finding of data elements required for processing can be achieved.

The description list is preferably generated such that the description list can be assigned to a terminal functionality, in particular the terminal's computing power or playback unit. This provides a simple method whereby a terminal with a specific terminal functionality can rapidly find the data elements it requires in the file. In addition, by specifying a plurality of description lists, terminals with different terminal functionalities can be served.

If, preferably, references for finding the appropriate data elements are added to the description list and the data elements are stored in an organized manner in a data area of one of the files, the description list and the data area can be managed separately from one another and e.g. transmitted separately from one another when the file or files are transferred. For the transmission, a specific error protection for the description list and the data area can be used in each case, by which bandwidth can be achieved compared to a single error protection.

If, in addition, the value of the processing index of the data element is determined from the reference associated with the data element, the data volume of the description list to be stored can be reduced.

Preferably the data elements can additionally be stored in an organized manner in the data area as a function of the reference associated with the respective data element. This means that the associated processing index can be determined by a position of the stored data element, thereby enabling on the one hand the volume of data to be reduced by omitting the specific processing index. On the other hand, the data area only needs to be processed in one direction for reading the data elements, thereby avoiding time-consuming jumps.

In an alternative extension of the method, in addition to a description list a data list compliant with an MPEG-4 AVC description format for MPEG4 AVC-compatible data elements for describing one of the lowest quality levels is stored in an organized manner in one of the files. The MEPG-4 AVC description format is known from the ISO/IEC MPEG-4 AVC standard. This means that the file can also be read and evaluated by terminals which only know the MEPG-4 AVC description format.

In addition, quality groups are preferably formed from the quality levels such that the quality group is assigned to one of the quality levels and all the data elements for processing are allocated to the quality group, thereby enabling a scalable coding method to be supported which supports a plurality of scaling levels in a layered manner.

If for this purpose in the description list only those data elements or references are allocated to the quality group which are added or required for forming the quality group in addition to the data elements or references in the next lower listed quality group to the quality group, a compact and memory-efficient representation of the description list can be thereby ensured.

The method can be used by a device for storing individual data elements of a scalable bit stream in at least one file, whereby quality levels of the scalable bit stream are described by at least one scaling feature in a plurality of scaling levels in each case, each scaling level of the scaling features is assigned at least one data element in each case, the scalable bit stream is represented at a high quality level by at least one of the data elements whose scaling feature scaling levels are equal to or less than the scaling feature scaling levels associated with the high quality level, and the data element is assigned a time index at which the respective data element is to be represented relative to other data elements, the device having a generator module such that the data element is assigned a processing index such that, to process the data element, only one or a plurality of data elements with a lower value of the respective processing index must be taken into account, at least one description list is generated such that it contains data-element-associated description elements containing the scaling level of the respective scaling features, the time index and/or the processing index, and at least one of the description lists and the associated data elements are stored in an organized manner in one of the files.

The method can be implemented and executed using this device. The device can be realized in hardware, in software running on a processor or from a combination of hardware and software.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a graph illustrating quality levels of a scalable bit stream;

FIG. 2 is a timing and data flow diagram illustrating procedures for achieving data elements which represent different scaling features (frame rate and picture resolution);

FIG. 3 is a graph illustrating description elements and data element for each quality level;

FIG. 4 is a block diagram of a circuit for the generation of data elements from a plurality of pictures and for the creation of reconstructed pictures;

FIG. 5A is a block diagram illustrating a procedure for creating a reconstructed picture for the quality level with high picture resolution;

FIG. 5B is a block diagram illustrating a procedure for creating a reconstructed picture for the quality level with high frame rate;

FIG. 6 is a table containing a description list for the quality levels or data element according to FIGS. 2 and 3 respectively;

FIG. 7 is a file structure diagram of a file containing a description list and a data area;

FIG. 8A is a table containing a variant of a description list;

FIG. 8B is a table containing the description list according to FIG. 8A in binary notation;

FIG. 9 is a block diagram illustrating a device for storing individual data elements of a scalable bit stream to a file;

FIG. 10 is a block diagram illustrating an example of using the device within a video server in a network;

FIG. 11 is a table containing a description list taking quality groups into account;

FIG. 12 is a table containing another variant of a description list taking equipment characteristics into account;

FIG. 13 is a block diagram illustrating dependencies of a number of pictures in a description list;

FIG. 14 provides file structure diagrams of two files, a plurality of description lists and a data list being stored in an organized manner in the first file and the data elements being stored in an organized manner in the second file.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

The method for storing individual data elements of a scalable bit stream to a file will now be explained in greater detail with reference to a video bit stream. The video bit stream represents a possible type of scalable bit stream. Other types of scalable bit streams are, for example, a voice signal, a music track or a data record which can be represented in a plurality of quality levels.

Scalable video bit streams typically possess the characteristic that parts of these bit streams can be decoded in reduced quality, e.g. lower sharpness, lower spatial or temporal resolution and/or omission of particular objects. With certain coding methods it is possible to extract any coherent subsets from the complete bit stream, resulting in a reduced spatial and/or temporal resolution and/or less sharpness. In addition, sections of the scalable bit stream SD can be marked according to intended use, e.g. certain scenes of the scalable bit stream are only accessible to particular age groups.

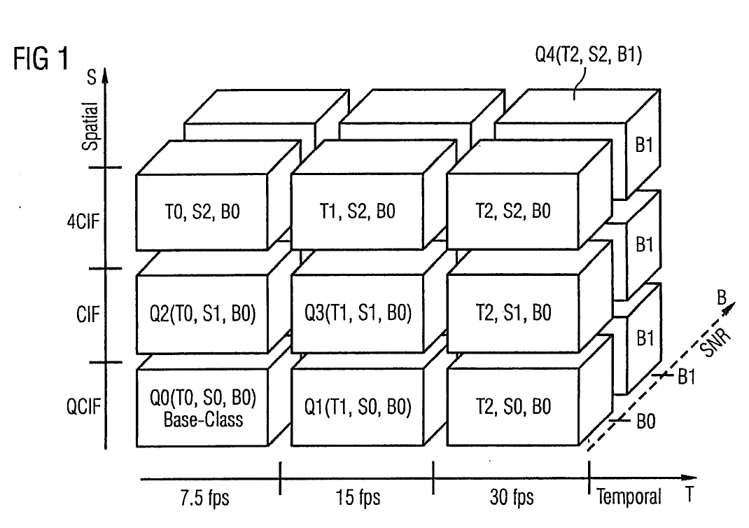

FIG. 1 illustrates the concept of “fully scalable” video coding. Plotted along the axes are three scaling features, frame rate T, spatial resolution S and picture sharpness B. Each of the scaling features T, S, B is resolvable into a plurality of scaling levels. Here T0=7.5 fps (fps—frames per second), T1=15 fps and T2=30 fps. In addition, the scaling levels of the spatial resolution S in FIG. 1 are S0=QCIF (QCIF=Quarter Common Intermediate Format=176×144 pixels), S1=CIF (CIF—Common Intermediate Format=352×288 pixels) and S2=4CIF (4CIF—4 times Common Interchange Format=704×576 pixels). Lastly the scaling feature picture sharpness B has two scaling levels B0, B1, where B0 corresponds to coarse quantization and B1 to fine quantization.

In FIG. 1 each box represents one of the possible quality levels Q0, . . . , Q4, each quality level being represented by an individual triple of scaling levels of the scaling features T, S, B. For example, the quality level Q3 is characterized by the scaling levels T1, S1, B0 of the scaling features T, S, B. In FIG. 1 each quality level Q0, . . . Q4 represents a particular quality of the scalable bit stream SD, the quality of the quality level Q0 being low, as the frame rate, the spatial resolution and the picture sharpness are all low or coarse. To improve the quality of the scalable bit stream SD, the second quality level Q2, for example, is selected, thereby increasing the spatial resolution S from QCIF to CIF. Therefore, in the case of a “fully scalable” coding method, as shown in FIG. 1, an improvement in picture quality can be achieved by traveling along the axes representing the individual scaling features.

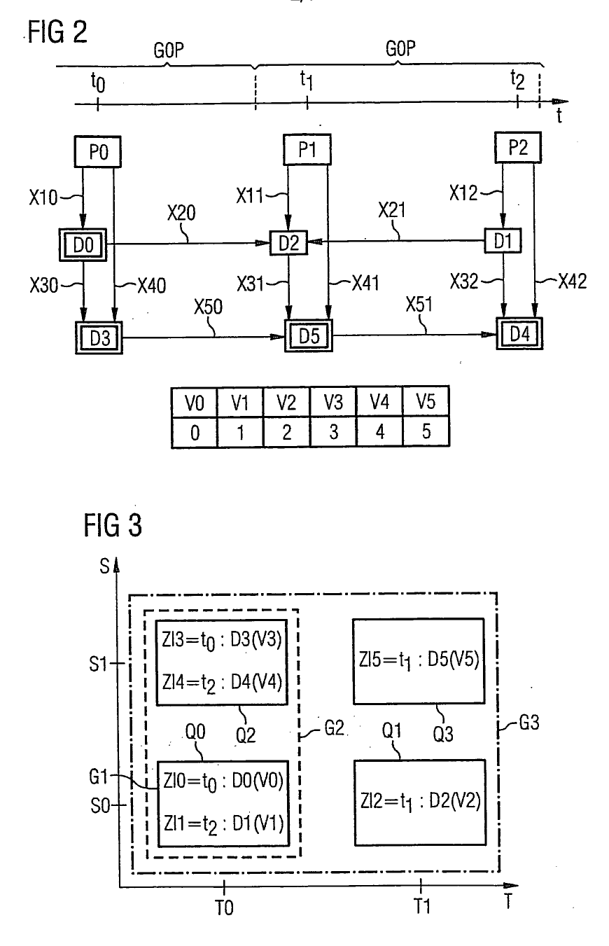

With the aid of FIGS. 2 to 5B, the generation or coding and processing or decoding of the scalable bit stream will be examined in greater detail in the following. Methods for coding and decoding a scalable bit stream, such as the ISO/IEC MPEG standardization activities relating to SVC (SVC—Scalable Video Coding) will be known to the person skilled in the art. Therefore, the coding and decoding of a scalable bit stream will only be explained in general terms with the aid of FIGS. 2 to 5B. A scalable bit stream or more precisely data elements of a scalable bit stream are to be generated which will provide a frame rate of T0=15 fps and T1=30 fps, and a spatial resolution S0=QCIF and S1=CIF. As shown in FIG. 3, four different quality levels Q0, . . . Q3 can therefore be implemented. For each quality level at least one data element D0, . . . , D5 is generated containing the relevant data of the respective quality levels Q0, . . . , Q3.

The generation of the data elements D0, . . . , D5 will be examined in greater detail with reference to FIG. 2. For the generation of these data elements, three pictures P0, P1, P2 are considered which have been captured at the times t0, t1, t2. These pictures P0, P1, P2 have a spatial resolution of CIF. First, in an initial step X10, the picture P0 is converted from CIF to QCIF, e.g. by using a two-dimensional subsampling filter, and optionally compressed so that the data element D0 is produced as a result. This step is performed analogously in step X12 for the picture P2 to produce the data element D1. To generate the data element D2, in step X11, for example, the picture P1 is first converted from CIF to QCIF, and then a difference picture in the form of a B-picture is produced by the decompressed data elements D0, D1 (steps X20, X21). The difference picture is compressed, thereby producing the data element D2.

In a next step X30, the decompressed data element D0 is enlarged from QCIF to CIF, e.g. by using a two-dimensional filter. Then in step X40 a difference picture is determined from the picture P0 and the enlarged and decompressed data element D0 and is compressed. The compressed difference picture is designated data element D3. The data element D4 is created in a similar manner by steps X32 and X42.

To produce the data element D5, first the data element D2 is decompressed in step X31 and enlarged from QCIF to CIF. Then a difference picture is created taking into account the picture P1, the decompressed and enlarged picture D2 and the decompressed and reconstructed pictures on the basis of the data elements D0, D3 and the data elements D1 and D4, one of the reconstructed pictures being determined in step X50 from the decompressed data element D0 enlarged from QCIF to CIF together with the decompressed data element D3. In step X51 this is performed in a similar manner for the data elements D1 and D4. Generation of the difference picture and its compression also take place in step X41, so that the data element D5 is produced there.

In FIG. 3, spatial resolution S and frame rate T of the data elements generated in FIG. 2 are plotted along the scaling levels of the scaling features. In addition, a respective time index Z0, . . . , ZI5 at which the associated data element is to be output, i.e. displayed on a screen, for example, is specified.

Additionally listed in FIG. 3 for each data element D0, . . . , D5 is an associated processing index V0, . . . , V5. The processing index specifies the sequence in which the individual data elements must be processed, e.g. decompressed and handled. If, for example, the data element D4, i.e. the quality level Q2, is to be processed, at least the data element D1 must have been processed, e.g. decompressed and enlarged. In general the processing index indicates that, prior to processing of the associated data element D4, one or more data elements D1 with a smaller value of the processing index V1 must already have been processed. Tabulated at the bottom of FIG. 2 are values for the respective processing index V0, . . . , V5 of the associated data element D0, . . . , D5. This listing is by way of example and can also be represented by one or more alternative sequences.

In FIGS. 2 and 3, only a small number of pictures, e.g. P0, P1 and P2, have been considered. For a scalable bit stream DS, a large number of pictures is taken into account for which data elements are generated in each case. It is also pointed out that compression or decompression is optional. The compression or decompression can be provided by the ISO/IEC MPEG-4 AVC standard.

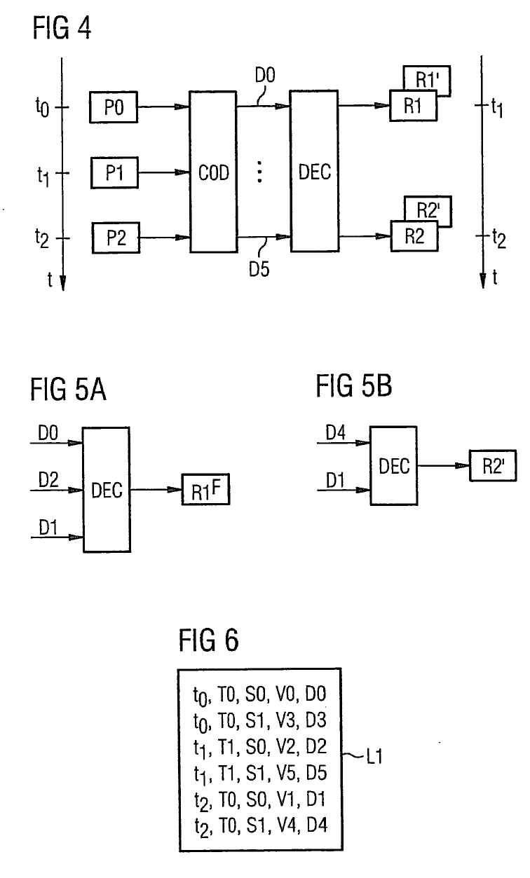

FIG. 4 shows a circuit schematic for generating data elements from a plurality of pictures and for creating reconstructed pictures. As is known e.g. from FIG. 2, the data elements D0, . . . , D5 are generated from the pictures P0, . . . , P2 with the aid of a coding module COD. Using a decoding module DEC, one or more reconstructed pictures R1, R1′, R2, R2′ can be generated from one or more data elements, the reconstructed pictures R1, R2 having a low spatial resolution S0 and the pictures R1′, R2′ a high spatial resolution S1. If only the pictures of the low frame rate T0, i.e. the reconstructed pictures R1 or R1′, are displayed, the frame rate T0=7.5 fps. If the reconstructed pictures R2 or R2′ are additionally displayed, a reconstructed bit stream of T1=15 fps is produced.

In FIGS. 5A and 5B the procedure for generating reconstructed pictures is explained in greater detail. If, for example, the reconstructed picture R1 corresponds to the quality level Q1 shown in FIG. 3, the data elements D0, D1 and D2 are required to create it. This dependency can be seen from FIG. 2. If the quality level Q2 has been selected, the reconstructed picture R2′ is created by the data elements D1 and D2 as shown in FIG. 5B.

Because of this modular procedure for generating reconstructed pictures, depending on its terminal functionalities, a terminal can consider only the quality level and therefore only those data elements which it can e.g. process or display.

It is also observed that a scalable bit stream of a high quality level takes into account the data element of the high quality level as well as one or more data elements of the lower quality levels. This means that the scalable bit stream of a high quality level is reproduced by one or more of those data elements which belong to scaling features scaling levels equal to or less than the scaling feature scaling levels associated with the high quality level. This type of scaling is also known as “full scalability”. For example, if the high quality level is Q3, to generate the scalable bit stream DS in this quality the data packet D5 and also e.g. all the data packets of the lower quality levels, namely D0, . . . , D4, must be taken into account.

In a subsequent operation of the method, a description list L1 is compiled by sorting the description elements which include, e.g., the scaling levels of the scaling features, and/or the time index ZI9, . . . , ZI5 and/or the processing index V0, . . . , V5. A typical result of this sorting is shown in FIG. 6, in which the following three sort criteria have been executed in the following sorting sequence:
1. Time index ZI0, . . . , ZI5 or t0, . . . , t2
2. Frame rate T0, T1
3. Spatial resolution S0, S1.

The description list L1 is disposed in the file F such that after specifying the sorting parameters the associated data element is specified together with its processing index, such as, for example, “t0, T0, S0, V0, D0”.

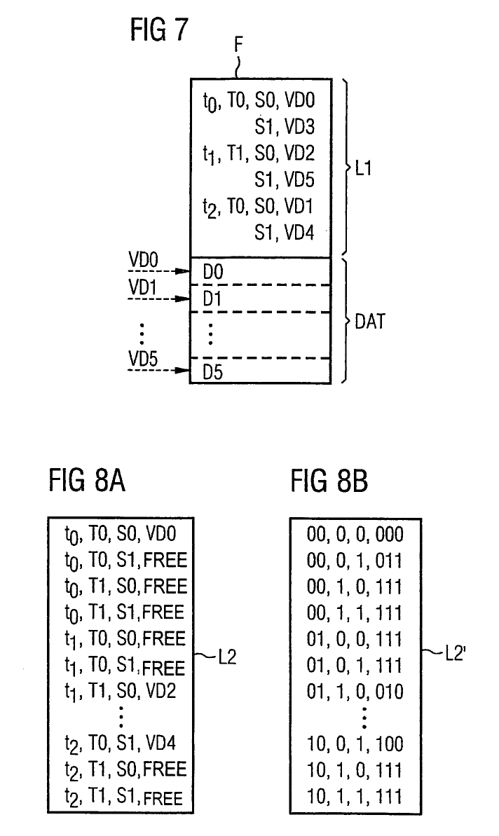

FIG. 7 shows an alternative form of representation of the description list from FIG. 6. Here instead of the processing index V0, . . . , V5 and the associated data element DO, . . . , D5 a respective reference VD0, . . . , VD5 is inserted into the description list L1. This reference VD0, . . . , VD5 has two functions. On the one hand it points to an entry within a data section DAT of the file F in which the individual data elements D0, . . . , D5 are stored in an organized manner. This enables the data element D0, . . . , D5 to be found by the reference VD0, . . . , VD5. This is symbolically indicated in FIG. 7 using dashed arrows denoted by VD0, . . . , DV5. On the other hand, the processing index V0, . . . , V5 associated with the respective data element D0, . . . , D5 can be obtained from the reference VD0, . . . , VD5. Thus the processing index V0 can be determined from the position of the data element D0 within the data section DAT. If the data element D0 is in the first position, the associated processing index V0=0. If the data element D0 is in the fourth position, the processing index V0=3. The same applies analogously to the other data elements D1, . . . , D5.

In the above examples according to FIGS. 6 and 7, the data elements and the description list are stored in a sorted manner in a single file F. In general these can be stored in more than a single file, e.g. the description list L1 in the file F and the data elements D0, . . . , D5 in another file F1.

FIG. 8A shows another alternative form of representation of the description list L2. Here those entries within the description list L2 for which no data element exists are assigned a marking word “FREE” instead of the reference.

FIG. 8B shows the entries of FIG. 8A in binary notation. This is e.g. a description list L2′, the description elements assuming the following binary values:
00: t0, 01: t1, 10: t2
0: T0, 1: T1
0: S0, 1: S1
VD0: 000, . . . , VD5: 101, FREE: 111

For example, the fourth line has the following bit pattern: “00, 1, 1, 111”. If the individual binary symbols are replaced by the previously mentioned reference characters, this fourth line can be read as: “t0, T1, S1, FREE”. The meanings of the binary signals t0, t1, T0, T1, S0, S1, D0, D1, D2, D3, FREE are e.g. a priori known to a decoder or terminal or are notified separately thereto.

In FIGS. 6 to 8B a uniform sorting sequence has been selected. This constitutes one of the possible embodiments of the method. In general any sequence for sorting the description elements, i.e. the time index and the scaling levels of the scaling features, for example, can be considered. In particular, for compiling the description lists, terminal functionalities such as computing power or playback unit of a terminal can be taken into account. For example, a scalable bit stream SD with a maximum spatial resolution of S0=QCIF can be processed and displayed on a terminal. FIG. 12 shows by way of example a description list L4 according to the following sorting sequence:
4. Spatial resolution S
5. Time index or time instant
6. Frame rate T.

When evaluating the description list L4 the terminal only searches in that section of the file F which has the spatial resolution S0 as the first sorting parameter. The terminal does not need to search for possible data elements in the section of the description list L4 which begins with the spatial resolution S1, as the terminal cannot process and display a spatial resolution S1.

In addition, individual data elements and/or scaling levels of scaling features and/or time indices can be marked with an access index. The access index provides an additional sort criterion for selecting the data elements to be processed. Thus time sections of the scalable bit stream SD can be approved for adults only, while other time sections are suitable for young people aged 12 to 18. By marking the time indices ZI0, . . . , ZI5 by an access index in each case, processing of undesirable data elements can be prevented or permitted.

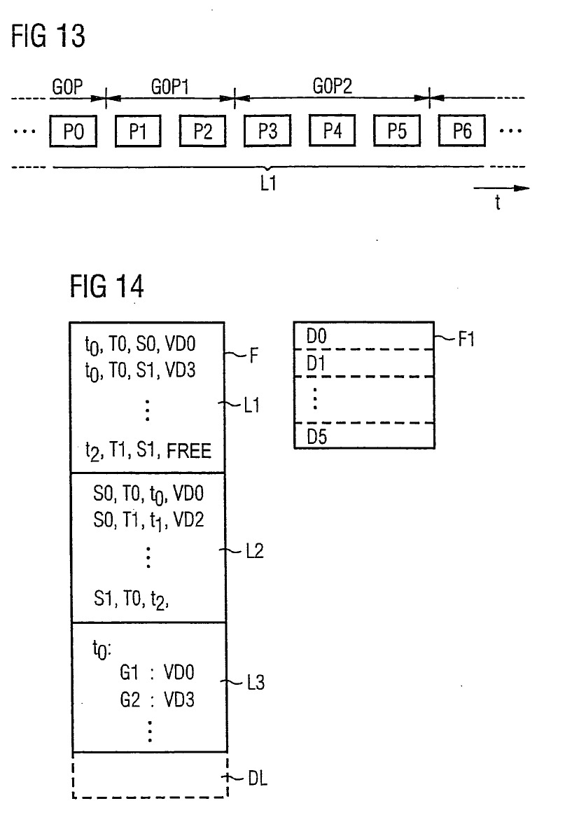

With reference to the exemplary embodiment shown in FIG. 2, three pictures P0, . . . , P2 are processed, a constraint length of the processing (=coding) being GOP=2, as apart from one auxiliary picture P0 required for processing, the constraint length covers the pictures P1 and P2. In general any constraint length GOP can be represented using the method described herein. If a larger constraint length GOP, e.g. GOP=16, is selected, a number of scaling levels of the scaling feature frame rate T can be increased. FIG. 13 shows by way of example that the constraint lengths GOP, GOP1, GOP2 can change over time t, e.g. GOP1=2 pictures, GOP2=3 pictures.

In an extension of the method, more than one description list L1, L2, 13 can be contained in the file F, a terminal being able to select individually one of the description lists for processing the data elements. For example, by specifying a number of a description list L1, a particular procedure for processing the data elements can be predefined for the terminal. For example, a terminal is only to be allowed scalability in quality groups. For this purpose the terminal is only instructed to process the description list L3. This description list L3 will be explained later.

In an alternative extension of the method, a data list DL can be added to the file F, MPEG-4 AVC-compatible data elements for describing one of the lowest quality levels Q0, Q1 being stored in an organized manner in one of the files F, F1 by the data list DL in accordance with an MPEG-4 AVC description format. In this way, backward compatibility to existing terminals which cannot evaluate the description lists L1 can be achieved in the file. In FIG. 14 the optional data list DL has been inserted in the file F.

Additionally or alternatively, the description list L1 and the data area DAT can be stored in a file F or in a plurality of files F, F1. As shown in FIG. 14, the description lists L1, . . . , L3 are stored in an organized manner in the file F and the data area DAT in the other file F1.

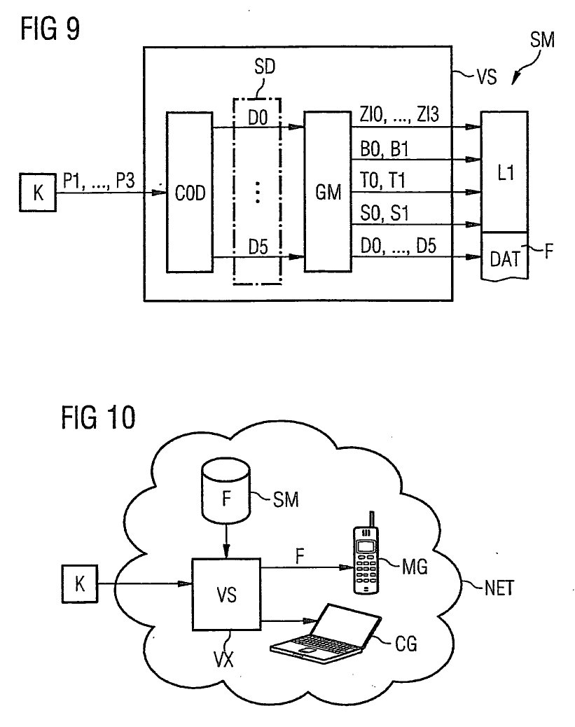

FIG. 9 shows an exemplary embodiment of a device for carrying out the method. In this example, uncoded pictures P1, . . . , P3 are taken by a camera K and transferred to the coding module COD which generates the data elements D0, . . . , D5. These are transferred to a generator module GM which, after sorting of the description elements, generates at least one of the description lists L1 and stores it in an organized manner in at least one of the files F. In addition, the generator module GM creates the data area DAT containing the data elements D0, . . . , D5 within one of the files F, F1, the file F being stored e.g. on a storage module SM, in particular a hard disk.

FIG. 10 shows a possible example of the application of the device. Within a network NET there is a video server VX incorporating the device. The storage module SM with the file F can be linked to the video server VX. In addition, a camera K can be connected to the video server VX. The video server VX is additionally capable of transmitting the created file or files containing the description list L1 and the data area DAT to a mobile communication device MG, such as a GSM device (GSM—Global System Mobile Communications) or to a computer CG.

In a variant of the method, the description list L3 can be generated such that the data elements belonging to a respective time index are combined into quality groups G1, . . . , G3. In this connection, reference will first be made to FIG. 3 in which the quality groups G1, . . . , G3 are marked. In the example shown in FIG. 3, not all the quality levels can any longer be specifically selected by the quality groups G1, . . . , G3. FIG. 3 contains three quality groups G1, . . . , G3. The first quality group G1 only includes the data elements D0, D1 of the quality level Q0. The second quality group G2 contains the data elements D0, D1, D3, D4 of the quality levels Q0 and Q1. The third quality group G3 includes the data elements D0, . . . , D5 of the quality levels Q0, . . . , Q3. The grouping into quality groups as shown in FIG. 3 will be known to the person skilled in the art as “layered coding” in the context of scalable coding. The layers are wherein it is no longer possible to achieve any combination of scaling levels of the scaling features.

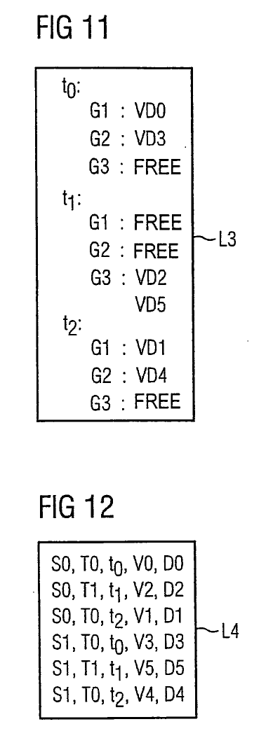

FIG. 11 illustrates another variant of a description list L3 which describes the quality groups G1, . . . , G3 and has been created according to the following sorting sequence:
1. Time index ZI0, . . . , ZI5,
2. Quality group G1, . . . , G3

The respective quality group G1, . . . , G3 is specified in place of the scaling features T, S. Instead of specifying all the data elements or references associated with each quality group, only those data elements or references which must be additionally taken into account compared to the next smaller quality group G2 for processing or rather decoding can be listed for quality group G3. For example, if a terminal selects the quality group G3, all the data elements or references of the lower quality groups G1 and G2 are also selected in addition to the data elements or references listed there. With this procedure, a compact and memory-efficient representation of the description list can be achieved using quality groups.

In the previous examples, only six data elements with the scaling features frame rate and (picture) spatial resolution are shown. The method may be implemented using more description elements, i.e. a larger number of scaling levels and/or scaling features. Thus in FIG. 1, for example, in addition to the frame rate T and the spatial resolution F, the picture sharpness B can be marked in a third dimension.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for storing data elements of a scalable bit stream individually in at least one file, comprising:
respectively describing quality levels of the scalable bit stream by at least one scaling feature, each scaling feature having a plurality of scaling levels;
obtaining at least one data element for respective scaling levels of the at least one scaling feature;
representing the scalable bit stream at a specified quality level by at least one of the data elements having at least one corresponding scaling level, each of which is not higher than a specified scaling level of a corresponding scaling feature at the specified quality level;
allocating to each respective data element a time index at which the respective data element is to be represented relative to other data elements;
assigning to each respective data element a specified processing index indicating that only any previously processed data elements, each having a lower processing index than the specified processing index, may be used in processing the respective data element;
generating at least one description list of description elements associated with a set of the data elements, the description elements for each data element in the set including at least one scaling level, a corresponding time index and/or a corresponding processing index; and
storing the at least one description list and the set of the data elements in an organized manner in the at least one file.

12. The method as claimed in claim 11, further comprising sorting the description elements in the description list according to at least one sort criterion.

13. The method as claimed in claim 12, wherein the description elements are sorted from the lowest scaling level to the highest scaling level.

14. The method as claimed in claim 13, wherein said generating of the description list enables the description list to be assigned to a terminal computing power or a playback unit of a terminal.

15. The method as claimed in claim 14,
further comprising adding to the description list references for finding associated data elements, and
wherein said storing stores the data elements in a data area in one of the files.

16. The method as claimed in claim 15, wherein said assigning of the specified processing index to each respective data element is based on a corresponding reference associated with the respective data element.

17. The method as claimed in claim 16, wherein said storing of the data elements in the data area utilizes the references associated with the data elements.

18. The method as claimed in claim 17, further comprising storing in an organized manner in one of the files, a data list compliant with an MPEG-4 AVC description format for MPEG-4 AVC-compatible data elements the scalable bit stream at one of the lowest quality levels.

19. The method as claimed in claim 18, further comprising:
forming from the quality levels, quality groups, each quality group assigned to one of the quality levels; and
allocating all of the data elements to processing of at least one of the quality groups.

20. The method as claimed in claim 19, wherein said generating of the description list includes only an additional set of the data elements or the references which are added to form a first quality group in combination with a previous set of the data elements or the references listed in a second quality group immediately lower than the first quality group.

21. The method as claimed in claim 12, wherein the description elements are sorted from the lowest scaling level to the highest scaling level.

22. A device for storing individual data elements of a scalable bit stream in at least one file, where quality levels of the scalable bit stream are described by at least one scaling feature, each having a plurality of scaling levels, each scaling level being assigned at least one data element, the scalable bit stream being represented at a specified quality level by at least one data element having at least one corresponding scaling level, each of which is not higher than a specified scaling level of a corresponding scaling feature at the specified quality level, and the at least one data element is allocated a time index at which the at least one data element is to be represented relative to other data elements, comprising:
a generator module
assigning each respective data element a specified processing index indicating that only any previously processed data elements, each having a lower processing index than the specified processing index, may be used in processing the respective data element,
generating at least one description list of description elements associated with a set of the data elements, the description elements for each data element in the set including at least one scaling level, a corresponding time index and/or a corresponding processing index, and
storing at least one of the description lists and the set of data elements in an organized manner in one of the files.
